(19) United States
(12) Patent Application Publication
(10) Pub. No.: US 2025/0087205 A1
(43) Pub. Date: Mar. 13, 2025

(54) DISCUSSION EVALUATION APPARATUS, DISCUSSION EVALUATION METHOD, AND PROGRAM

(71) Applicant: NIPPON TELEGRAPH AND TELEPHONE CORPORATION, Tokyo (JP)

(72) Inventors: Yoko TOKUNAGA, Tokyo (JP); Narichika NOMOTO, Tokyo (JP); Shiro OZAWA, Tokyo (JP)

(21) Appl. No.: 18/292,568

(22) PCT Filed: Aug. 4, 2021
(86) PCT No.: PCT/JP2021/028989

§ 371 Date: Jan. 26, 2024

(51) Int. Cl. G10L 15/14; G10L 15/02

(52) U.S. Cl. CPC G10L 15/14; G10L 15/02

(57) ABSTRACT

Provided is a dialogue evaluation device that evaluates a dialogue performed in a group of two or more participants, the dialogue evaluation device including: an activity score calculation unit that extracts one or more feature values as an activity score from dialogue data; a feature value weight calculation unit that extracts dialogue experience data from a past dialogue log, calculates a dialogue experience score obtained by digitizing a dialogue experience between participants from the dialogue experience data, and calculates a weight of each feature value in the activity score from the dialogue experience score; and a dialogue evaluation score calculation unit that calculates a dialogue evaluation score by using the activity score and the weight.

### TECHNICAL FIELD

The present invention relates to a technique for evaluating dialogues in a group including two or more dialogue participants (referred to as group dialogues).

### BACKGROUND ART

As a technique for evaluating group dialogues, there is a technique for estimating leadership and the degree of contribution from the number of utterances during a dialogue, the frequency of words included in spoken sentences, the number of times of nodding seen from camera images, and the like. There is also a technique for performing questionnaire evaluation such as how much contribution is directly made by the participant and whether the participant is satisfied, or a technique for making a third party evaluate the result of the dialogue. There is also a technique for evaluating system-generated sentences when evaluating dialogues by a dialogue system.

### CITATION LIST

### Patent Literature

PTL 1: Japanese Patent Application Publication No. 2012-242528

### Non Patent Literature

NPL 1: Indrani Bhattacharya, et al. “A Multimodal-Sensor-Enabled Room for Unobtrusive Group Meeting Analysis,” ICMI '18: Proceedings of the 20th ACM International Conference on Multimodal Interaction, PP. 347-355. https://dl.acm.org/doi/pdf/10.1145/3242969.3243022
NPL 2: Soomin Kim, et al. “Bot in the Bunch: Facilitating Group Chat Discussion by Improving Efficiency and Participation with a Chatbot,” CHI '20: Proceedings of the 2020 CHI Conference on Human Factors in Computing Systems, PP. 1-13. https://dl.acm.org/doi/pdf/10.1145/3313831.3376785

### SUMMARY OF INVENTION

### Technical Problem

In the related art, when evaluating a dialogue between dialogue participants, a dialogue obtained by digitizing an actual dialogue state such as the number of utterances of the dialogue participants and features of words is often used. Also, it is possible to acquire or estimate the personality and the sense of values such as the leadership of the dialogue participant and use the same for the evaluation of the dialogue.

However, the important point of the evaluation is different between a case of dialogue participants having a dialogue for the first time and a case of a continuing dialogue over a long period of time.

For example, when only participants who meet for the first time are gathered and only one discussion takes place, it is conceivable that participants may avoid showing their personality or sense of values on the surface or may place importance on brightening the mood without trying to understand the personality or sense of values of the other parties. When there is a clear goal such as arriving at a correct answer through the dialogue, it is conceivable to evaluate the entire dialogue and one's own behavior by placing importance on whether or not the goal was reached.

On the other hand, when the same members continuously have discussions over a long period of time such as in meetings of a company, brightening the mood is not considered important, and the important point is sometimes whether more advanced opinions have been expressed or whether consensus has been reached. Also, even when there is a clear goal as in the above-described example, in some cases, it is sufficient to reach the conclusion after continuing the discussion, and in other cases, it is not necessary to arrive at the correct answer only in the course of the dialogue.

In this way, even if the dialogue is of the same task-oriented type, the important points of the dialogue evaluation greatly depend on the relationship between the participants. Therefore, by digitizing the relationship and using them for dialogue evaluation, it is possible to perform a more accurate evaluation. However, the related arts (for example, PTL 1, NPL 1, and NPL 2) do not take the relationships between dialogue participants into consideration.

The present invention has been made in view of the above points, and an object of the present invention is to provide a technique capable of evaluating a dialogue performed in a group while taking relationships between dialogue participants into consideration.

### Solution to Problem

According to the disclosed technique, there is provided a dialogue evaluation device that evaluates a dialogue performed in a group of two or more participants, the dialogue evaluation device including:
an activity score calculation unit configured to extract one or more feature values as an activity score from dialogue data;
a feature value weight calculation unit configured to extract dialogue experience data from a past dialogue log, calculate a dialogue experience score obtained by digitizing a dialogue experience between participants from the dialogue experience data, and calculate a weight of each feature value in the activity score from the dialogue experience score; and a dialogue evaluation score calculation unit configured to calculate a dialogue evaluation score by using the activity score and the weight.

### Advantageous Effects of Invention

According to the disclosed technique, it is possible to evaluate a dialogue performed in a group while taking relationships between dialogue participants into consideration.

### BRIEF DESCRIPTION OF DRAWINGS

FIG. 1 is a configuration diagram of a dialogue evaluation device according to an embodiment of the present invention.

FIG. 2 is a flowchart for describing an operation of the dialogue evaluation device.

FIG. 3 is a diagram illustrating an example of a dialogue log database.

FIG. 4 is a diagram illustrating a hardware configuration example of a dialogue evaluation device.

### DESCRIPTION OF EMBODIMENTS

An embodiment of the present invention (present embodiment) will be described below with reference to the drawings. The embodiment described below is merely an example, and embodiments to which the present invention is applied are not limited to the following embodiment.

### Overview of Embodiment

First, the overview of the present embodiment will be described. In the present embodiment, a dialogue evaluation device 100, which will be described later, predicts a score obtained by digitizing an evaluation reflecting the degree of achievement, degree of satisfaction, degree of contribution, and the like of each dialogue among the dialogue participants in a group dialogue by two or more dialogue participants (which may be called members or participants).

The dialogue evaluation device 100 uses dialogue data in which a dialogue to be evaluated is recorded and dialogue experience data indicating past dialogue experiences between participants when performing evaluation. As the dialogue data, individuality data indicating the personalities and the sense of values of the participants constituting the dialogue group may be included.

The dialogue data is a record of dialogues in chronological order, and is, for example, voice data collected by a microphone, text data transcribed from each member's utterance, video data of the movement of each member, vital data such as a heartbeat of each member recorded using a device such as a smart watch, and the like. As described above, the dialogue data may include individuality data indicating the individuality of each participant participating in the dialogue, and may include, for example, the results of questionnaires on personality, data on individuality predicted from past data using existing technology, and data on attributes such as age, work history, and position.

The dialogue evaluation device 100 obtains the degree of activity of the dialogue from the dialogue data. The degree of activity is a value obtained by converting how lively the dialogue is, the uplifting feeling of the members, the individuality of the dialogue participants themselves, and the like into comparable numerical values. For example, as the degree of activity, in the case of voice data, the magnitude or change of voice of each participant can be used, in the case of text data, the number of utterances or the number of words uttered by each participant can be used, in the case of video data, the magnitude of gestures or nods can be used, and in the case of vital data, the speed or change of heartbeat can be used. Note that the degree of activity may be called a “feature value.”

The individuality data that can be included in the dialogue data is data expressed for each participant of the dialogue, and is data obtained by, for example, selecting an answer that suits oneself from options such as “I agree,” “I agree a little,” “I don't agree much,” or “I don't agree at all,” in response to the question “I like to talk about myself in front of others,” selecting words that match one's personality and sense of values from words such as “taciturn,” “talkative,” and “extrovert,” or evaluating each item on a nine-stage scale. Alternatively, data evaluated for each participant by others may be used as the individuality data, or a score of a result of predicting the individuality by using past dialogue data or the like may be used.

When the results of questionnaires related to personalities and attributes are used as the individuality data, the numerical value may be used as it is or the totaled value may be used as long as the answers to the questionnaires are made by stepwise numerical values. When the answer to the questionnaire is Yes/No, numerical values such as 1 for Yes and 0 for No is used. In the case of answering by a selection formula from items which are not continuous such as occupation and preference, it is possible to prepare feature values for the number of items, and convert them into vectors with 1 for the selected item and 0 for the others. In the case of free description, it is possible to use words included in the free description as feature values as they are, or classify the words into categories from the description content, prepare feature values for the number of categories, convert them into vectors with 1 for the selected item and 0 for the others, and use them as activation scores. Further, questions with different answer methods, such as questions with Yes/No answers, questions with answers on a seven-stage scale, and questions with free description may be mixed.

The dialogue experience data is obtained by digitizing the experience of the participants in the dialogue so far, and for example, the number of times participants had a dialogue with each other so far, the total time for which they have participated in dialogues with each other, and the like are used. Alternatively, a period in which the person is expected to have had a dialogue experience, such as a period in which they belonged to the same project at work or a period in which they were in the same class at school, may be substituted. One or a plurality of types of data used as the dialogue experience data may be used. For the dialogue experience data, when there are three or more participants, it does not matter how participants who have had the same dialogue experience are combined, such as using dialogues that all participants experienced together or combining participants to form pairs and using a dialogue experienced together by two people in each pair. For example, for all participants, dialogue data experienced together for all combinations of different numbers of participants may be extracted and used as dialogue experience data.

The dialogue evaluation device 100 calculates a dialogue evaluation score by combining the activity score obtained from the dialogue data and the dialogue experience score obtained from the dialogue experience data. A dialogue evaluation score is given to each participant here, and is a score that expresses the degree of achievement, degree of satisfaction, or degree of contribution of the participant in the dialogue. The dialogue evaluation score may be each score (vector) of the degree of achievement, degree of satisfaction, and degree of contribution, may be a score of any one of the degree of achievement, degree of satisfaction, and degree of contribution, or may be scores of any one or more of the degree of achievement, degree of satisfaction, and degree of contribution. By calculating statistics, such as the average of the scores of each participant, it is also possible to represent the scores of the entire group.

Hereinafter, the configuration and operation of the dialogue evaluation device 100 will be described in detail as an embodiment.

### Device Configuration

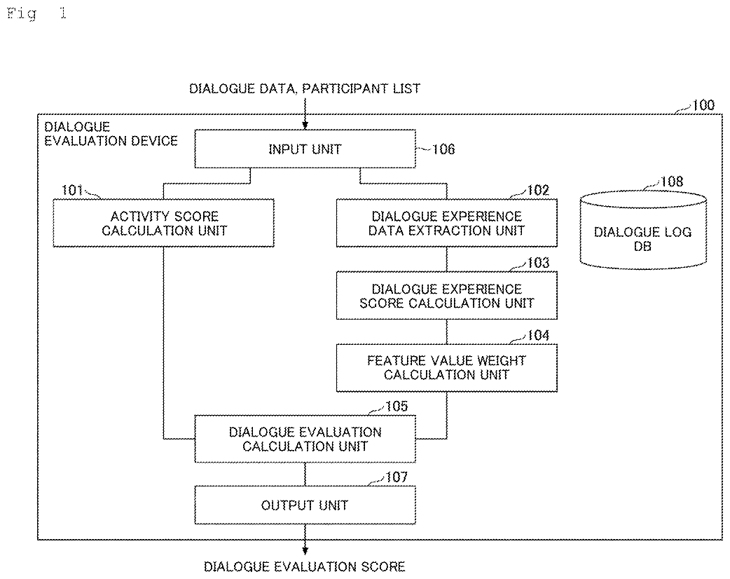

FIG. 1 illustrates a configuration example of the dialogue evaluation device 100 according to the present embodiment. As illustrated in FIG. 1, the dialogue evaluation device 100 includes an activity score calculation unit 101, a dialogue experience data extraction unit 102, a dialogue experience score calculation unit 103, a feature value weight calculation unit 104, a dialogue evaluation calculation unit 105, an input unit 106, an output unit 107, and a dialogue log database (DB) 108.

The dialogue log DB 108 may be provided outside the dialogue evaluation device 100 and connected to the dialogue evaluation device 100 via a network. Also, the feature value weight calculation unit 104 may include the dialogue experience data extraction unit 102 and the dialogue experience score calculation unit 103.

### Operation Example of Device

Next, an operation example of the dialogue evaluation device 100 will be described. In the operation example described below, the number of participants in the dialogue to be evaluated is k, and the k participants are defined as h₁, . . . , hₖ. The dialogue evaluation scores of the participants are defined as s₁, . . . , sₖ, and are calculated by the dialogue evaluation device 100.

Dialogue data and a participant list (h₁, . . . , hₖ) are input from the input unit 106. In the present embodiment, as dialogue data used for input, transcripts of utterances made by each participant and personality traits of each participant acquired from a questionnaire survey are used. As described above, the dialogue data is not limited thereto, and data indicating the state of dialogue such as spoken voice, moving image, and biological sensor information may be used, or data indicating the attributes such as age, work history, and position and the individuality such as questionnaire results for asking the sense of values, experience, preference, etc. may be used. Also, the number of types of data is not limited.

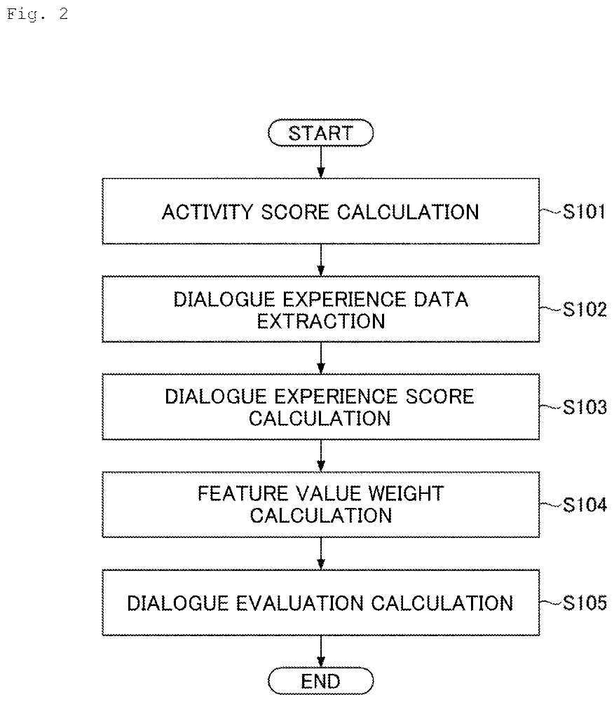

The procedure of the flowchart of FIG. 2 will be described below. Note that the order of calculation shown in the flow illustrated in FIG. 2 is an example. The order of calculation of the activity score, the dialogue experience score, and the like necessary for calculation of the dialogue evaluation score is arbitrary.

### <S101: Activity Score Calculation>

In S101, the activity score calculation unit 101 receives dialogue data as an input, extracts a feature value from the dialogue data, and outputs the feature value. Here, the total utterance time (u₁, . . . , uₖ) of each participant, the number of back channels (b₁, . . . , bₖ) of each participant, the number of important word utterances (w₁, . . . , wₖ) of each participant, and the personality trait score (p₁, . . . , pₖ) are extracted as feature values.

Here, the back channel refers to a response or the like, and for example, it can be extracted by a definition such that utterances that do not include verbs, nouns, adjectives, numerals, etc. are used as back channels. The number of important word utterances refers to the number of utterances of a word included in a word list determined to be important in advance. As the personality trait score, the results of questionnaires are totalized and numerical values obtained by using a classification method such as a BigFive personality trait or an existing scale is used.

Each feature value of each participant may be either a scalar value or a vector value, and for example, as the number of important word utterances wᵢ=(w′ᵢ₁, . . . , w′_{ic}), the number of appearances of each of c words may be used as a feature value, or as the personality trait score pᵢ=(p′ᵢ₁, . . . , p′_{id}), d types of personality trait factors or attributes may be used as feature values. Further, the feature value is not necessarily required for each of all the participants, and for example, only the feature value of the person who is the object of the dialogue evaluation may be extracted and used, or a value obtained by totaling the average, maximum value, minimum value, and dispersion of all the participants may be used.

The feature value is not limited to the above-described one, and may be any numerical value that can be extracted and calculated from the dialogue data, such as the average volume and maximum volume of the microphone, the number of times of operations such as nodding, and the number of times of exceeding the maximum heart rate and the average heart rate. Further, attributes such as age and position may be classified from data indicating individuality, and numerals representing groups to which participants belong may be used as feature values. In the present embodiment, as shown below, the feature values a₁, . . . , aₗ obtained by connecting the feature values extracted as described above are used as activity scores.

$$A = ( \begin{matrix}{a}_{1} \\ ⋮ \\ {a}_{l}\end{matrix} ) = ( \begin{matrix}{u}_{1} \\ ⋮ \\ {u}_{k} \\ {b}_{1} \\ ⋮ \\ {b}_{k} \\ {w}_{1} \\ ⋮ \\ {w}_{k} \\ {p}_{1} \\ ⋮ \\ {p}_{k}\end{matrix} ) \qquad [ Math . 1 ]$$

### <S102: Dialogue Experience Data Extraction>

In S102, the dialogue experience data extraction unit 102 extracts dialogue experience data from the dialogue log DB 108. The dialogue experience data refers to logs of past dialogues that the dialogue participants have participated so far.

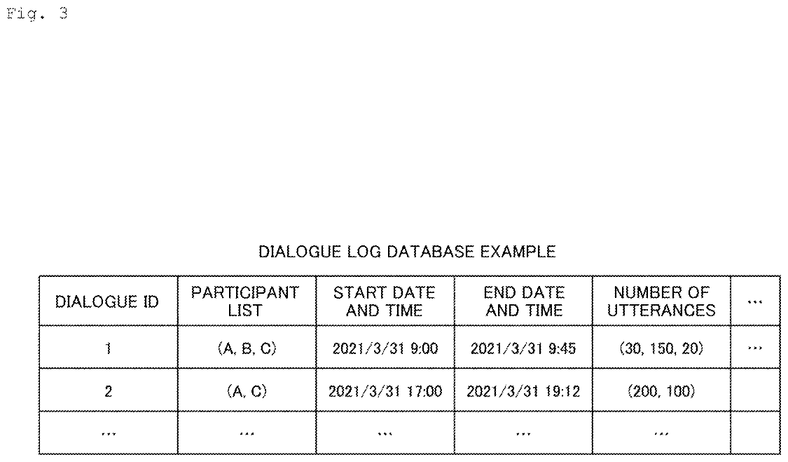

FIG. 3 illustrates an example of the dialogue log DB 108 storing dialogue logs. As illustrated in FIG. 3, the dialogue log includes a dialogue participant list and data indicating how long the participants have had a dialogue with each other, such as a dialogue time (start date and time, end date and time) and number of utterances. For example, in the dialogue with dialogue ID=2 in FIG. 3, it is shown that participant A and participant C had a dialogue from 17:00 to 19:12 on Mar. 31, 2021, and that the number of utterances of participant A is 200 times and the number of utterances of participant C is 100 times.

The dialogue experience data extraction unit 102 extracts dialogue experience data in which the dialogue participant to be evaluated has participated from the dialogue log DB 108. At this time, only the data in which all the dialogue participants participate together may be extracted, or a plurality of combinations such as data in which some participants participate together may be extracted. In the present embodiment, a log of the dialogue in which all the dialogue participants participate together and a log of the dialogue in which the dialogue participants are paired together and the two-person pairs participate together are extracted as dialogue experience data.

### <S103: Dialogue Experience Score Calculation>

In S103, the dialogue experience score calculation unit 103 receives the dialogue experience data extracted in S102 as an input, and calculates and outputs a dialogue experience score. Specifically, the dialogue experience score calculation unit 103 digitizes and extracts dialogue experiences performed in the past by participants participating in the dialogue to be evaluated from the dialogue experience data.

More specifically, in the present embodiment, the number of past dialogues and the value of the frequency of dialogues in the most recent month are used as the dialogue experience score. The dialogue experience score calculation unit 103 calculates the number of past dialogues (sₐₗₗ, s₁₂, . . . , s₍ₖ₋₁₎ₖ) and the frequency of dialogues in the most recent month (fₐₗₗ, f₁₂, . . . , f₍ₖ₋₁₎ₖ) from the dialogue logs of all the participants and the two-person pairs output by the dialogue experience data extraction unit 102. Note that sₐₗₗ is the number of dialogues for all participants, and s₁₂ is the number of dialogues for the pair of participant 1 and participant 2. Also, fₐₗₗ is the frequency of dialogues in the most recent month for all participants, and f₁₂ is the frequency of dialogues in the most recent month for the pair of participant 1 and participant 2. Any unit may be used for the frequency of dialogues in the most recent month, and for example, the number of dialogues in the most recent month may be used.

As described below, in the present embodiment, the dialogue experience score calculation unit 103 outputs the concatenation of the number of past dialogues and the frequency of dialogues in the most recent month as a dialogue experience score E.

$$E = ( \begin{matrix}{e}_{1} \\ ⋮ \\ {e}_{m}\end{matrix} ) = ( \begin{matrix}{s}_{all} \\ {s}_{12} \\ ⋮ \\ {s}_{( k - 1 ) k} \\ {f}_{all} \\ {f}_{12} \\ ⋮ \\ {f}_{( k - 1 ) k}\end{matrix} ) \qquad [ Math . 2 ]$$

### <S104: Feature Value Weight Calculation>

In S104, the feature value weight calculation unit 104 receives the dialogue experience score as an input, and calculates and outputs the weight of each feature value in the activity score. The weight of the feature value may be a continuous value corresponding to the continuous value of the dialogue experience score, or the weight of the feature value may be determined for each class by performing classification according to the size and distribution of the dialogue experience score.

As a method of generating the weight, for example, there is a method of generating and using a model that outputs the weight of the feature value when the dialogue experience score E is input by using data annotated by participants with dialogue evaluation scores in past dialogue logs. Such a model may be, for example, a machine learning model such as a neural network.

For example, assuming that the above model is expressed by a function f and the weight of the feature value is w, the feature value weight calculation unit 104 can calculate the weight as F(E)=w. When generating the model, an activity score A may be calculated by using the annotated dialogue log, and the parameters of the model f may be adjusted so that “(f(E))A” becomes a dialogue evaluation score s of the correct answer.

By using the dialogue evaluation score s of the specific participant as the dialogue evaluation score s of the correct answer, a weight w capable of calculating the dialogue evaluation score s of the specific participant can be obtained. Further, by using the dialogue evaluation score s (for example, a vector having a degree of satisfaction and a degree of contribution as elements) of a specific factor as the dialogue evaluation score s of the correct answer, a weight w capable of calculating the dialogue evaluation score s of the specific type can be obtained.

It is assumed that the weight of the feature value includes a value that indicates which feature value should be considered more in the dialogue evaluation among the feature values included in the activity score, and for example, w=(w₁, . . . , wₗ) can be expressed. Here, an arbitrary wᵢ corresponds to aᵢ included in the activity score A, and is a value that can determine how important each feature value aᵢ is to be given by the weight wᵢ. Although w is a vector in the above example, w may be a matrix.

As described above, since the dialogue experience score E is used when calculating the weight w, the weight w in which dialogue experience (relationship between dialogue participants) is taken into consideration can be obtained.

### <S105: Dialogue Evaluation Calculation>

In S105, the dialogue evaluation calculation unit 105 calculates a dialogue evaluation score sᵢ of a certain dialogue participant hᵢ by using the activity score A and the weight w of each feature value as follows. The calculated result is output from the output unit 107.

sᵢ=wA

In the above example, since w and A are vectors, the dialogue evaluation score is a scalar value. The feature value in the activity score A in the above formula may be only the feature value related to the participant hᵢ of the score calculation object, or may include a feature value other than the feature value related to the participant hᵢ of the score calculation object.

The calculation of the dialogue evaluation score as the scalar value as described above is an example, and the dialogue evaluation score may be calculated as a vector value. For example, when the dialogue evaluation score is calculated as a vector value by using a matrix as w, the dialogue evaluation may be determined by the size of the vector, or elements of each vector may be factors of dialogue evaluation such as “degree of agreement,” “degree of activity” and “degree of satisfaction.”

By executing the calculation of the above formula sᵢ=wA for each participant, the dialogue evaluation score of each participant can be obtained. However, obtaining the dialogue evaluation score of each participant is an example.

The activity score related to the dialogue of all participants is included as the feature value, and a weight based on the dialogue experience of all participants is calculated in the feature value weight calculation unit 104, so that the calculation result of the wA can be used as the evaluation score of the entire dialogue regardless of the participants.

Further, after obtaining the dialogue evaluation score of each participant, the statistics (for example, average, total) may be used as the evaluation score of the entire dialogue in the group.

### (Hardware Configuration Example)

The dialogue evaluation device 100 can be implemented by, for example, causing a computer to execute a program. This computer may be a physical computer, or may be a virtual machine on a cloud.

In other words, the dialogue evaluation device 100 can be implemented by executing a program corresponding to the processing performed by the dialogue evaluation device 100 using hardware resources such as a CPU and a memory that are built into the computer. The program can be recorded in a computer-readable recording medium (such as a portable memory) to be saved or distributed. Furthermore, the program can also be provided through a network such as the Internet or an electronic mail.

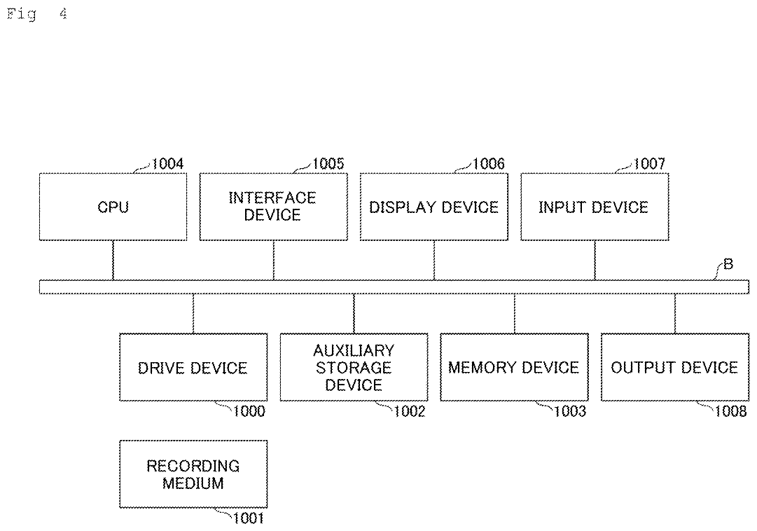

FIG. 4 is a diagram illustrating a hardware configuration example of the computer. The computer illustrated in FIG. 4 includes a drive device 1000, an auxiliary storage device 1002, a memory device 1003, a CPU 1004, an interface device 1005, a display device 1006, an input device 1007, an output device 1008, and the like, which are connected to each other via a bus BS.

The program for implementing the processing in the computer is provided by, for example, a recording medium 1001 such as a CD-ROM or a memory card. When the recording medium 1001 in which the program is stored is set in the drive device 1000, the program is installed from the recording medium 1001 to the auxiliary storage device 1002 through the drive device 1000. However, the program need not necessarily be installed from the recording medium 1001, and may be downloaded from another computer via a network. The auxiliary storage device 1002 stores the installed program and stores necessary files, data, and the like.

The memory device 1003 reads and stores the program from the auxiliary storage device 1002 when there is an instruction to start the program. The CPU 1004 implements functions related to the dialogue evaluation device 100 according to the program stored in the memory device 1003. The interface device 1005 is used as an interface for connection to a network or the like. The display device 1006 displays a graphical user interface (GUI) or the like according to a program. The input device 1007 includes a keyboard and mouse, buttons, a touch panel, or the like, and is used to input various operation instructions. The output device 1008 outputs a calculation result.

### SUMMARY OF EMBODIMENTS, EFFECT

Evaluation of group dialogue is affected by the utterance and behavior of participants in actual dialogues and the relationships between participants. Since the relationship between participants changes, such as the more experience they have in dialogue together, the deeper the relationship becomes, in the present embodiment, it is possible to accurately determine the evaluation of the dialogue by expressing this as the dialogue experience score and combining the dialogue experience scores.

In other words, in the present embodiment, when evaluating the group dialogue, the dialogue evaluation score is obtained on the basis of the activity score calculated from dialogue data indicating the state of dialogue and the individuality of the participants and the dialogue experience score calculated from dialogue experience data indicating the past dialogue experience between the participants of the dialogue. Thus, the evaluation representing the degree of contribution, degree of satisfaction, degree of achievement, or the like in consideration of the relationship between the participants can be predicted.

Further, from the predicted evaluation, it is possible to examine the organization of the group in which the degree of satisfaction of the participant is higher, or to intervene in the way of proceeding the dialogue. For example, in the case of a participant who places importance on the number of utterances in a dialogue between participants who meet for the first time, there is a likelihood that a dialogue with a high degree of satisfaction can be achieved by adding an intervention that increases the number of utterances.

Further, when a person makes a dialogue with the other party having no dialogue experience so much, the dialogue evaluation of the other party is predicted later, and a transaction necessary for improving the dialogue evaluation of the participant can be intentionally taken in the next dialogue or reflected in materials.

Alternatively, by virtually simulating the dialogue and observing the change in the dialogue evaluation of the dialogue participant, it is also possible to formulate a strategy for what kind of dialogue should be performed and what kind of intervention should be made.

### SUPPLEMENTARY NOTE

The present specification discloses at least a dialogue evaluation device, a dialogue evaluation method, and a program according to each of the following Items.

### Item 1

A dialogue evaluation device that evaluates a dialogue performed in a group of two or more participants, the dialogue evaluation device including:
an activity score calculation unit configured to extract one or more feature values as an activity score from dialogue data;
a feature value weight calculation unit configured to extract dialogue experience data from a past dialogue log, calculate a dialogue experience score obtained by digitizing a dialogue experience between participants from the dialogue experience data, and calculate a weight of each feature value in the activity score from the dialogue experience score; and a dialogue evaluation score calculation unit configured to calculate a dialogue evaluation score by using the activity score and the weight.

### Item 2

The dialogue evaluation device according to Item 1, in which the dialogue data includes individuality data including personality traits of participants constituting the group, and the one or more feature values include a feature value related to an utterance and a feature value related to a personality trait.

### Item 3

The dialogue evaluation device according to Item 1 or 2, in which the feature value weight calculation unit receives the dialogue experience score as an input and calculates the weight using a model that outputs the weight.

### Item 4

The dialogue evaluation device according to any one of Items 1 to 3, in which the dialogue evaluation score calculation unit calculates a vector having a plurality of factors of dialogue evaluation as a plurality of elements as the dialogue evaluation score.

### Item 5

The dialogue evaluation device according to any one of Items 1 to 4, in which the dialogue evaluation score calculation unit calculates a dialogue evaluation score of each participant in the group, and calculates a statistic of dialogue evaluation scores of all participants as the dialogue evaluation score of the entire group.

### Item 6

A dialogue evaluation method executed by a dialogue evaluation device that evaluates a dialogue performed in a group of two or more participants, the dialogue evaluation method including:
a step of extracting one or more feature values as an activity score from dialogue data;
a step of extracting dialogue experience data from a past dialogue log, calculating a dialogue experience score obtained by digitizing a dialogue experience between participants from the dialogue experience data, and calculating a weight of each feature value in the activity score from the dialogue experience score; and
a step of calculating a dialogue evaluation score by using the activity score and the weight.

### Item 7

A program for causing a computer to function as each unit in the dialogue evaluation device according to any one of Items 1 to 5.

Although the present embodiment has been described above, the present invention is not limited to such a specific embodiment, and various modifications and changes can be made within the scope of the gist of the present invention described in the claims.

### REFERENCE SIGNS LIST

100 Dialogue evaluation device
101 Activity score calculation unit
102 Dialogue experience data extraction unit
103 Dialogue experience score calculation unit
104 Feature value weight calculation unit
105 Dialogue evaluation calculation unit
106 Input unit
107 Output unit
108 Dialogue log DB
1000 Drive device
1001 Recording medium
1002 Auxiliary storage device
1003 Memory device
1004 CPU
1005 Interface device
1006 Display device
1007 Input device
1008 Output device

1. A dialogue evaluation device for evaluating a dialogue with a group of two or more participants, the dialogue evaluation device comprising:
circuitry configured to
extract one or more features that are used to determine an activity score, from dialogue data,
extract dialogue experience data from a previous dialogue log,
determine a dialogue experience score that is obtained by quantifying, based on the dialogue experience data, a dialogue experience with given participants among the two or more participants,
determine a weight of each of the features associated with the activity score, based on the dialogue experience score, and
determine a dialogue evaluation score based on the activity score and the weight of each of the features associated with the activity score.

2. The dialogue evaluation device according to claim 1, wherein the dialogue data includes personality data including personality traits of the two or more participants in the group, and the one or more features include a feature related to a speech and a feature related to a personality trait.

3. The dialogue evaluation device according to claim 1, wherein the circuitry is configured to determine the weight using a model that receives the dialogue experience score and that outputs the weight.

4. The dialogue evaluation device according to claim 1, wherein the circuitry is configured to determine a vector having a plurality of factors that are associated with dialogue evaluation and are used as respective elements, as the dialogue evaluation score.

5. The dialogue evaluation device according to claim 1, wherein the circuitry is configured to
determine a second dialogue evaluation score for each of the two or more participants in the group, and
determine a statistic of second dialogue evaluation scores for all participants of the group as the dialogue evaluation score for the entire group.

6. A dialogue evaluation method executed by a dialogue evaluation device that evaluates a dialogue with a group of two or more participants, the dialogue evaluation method comprising:
extracting one or more features used to determine an activity score, from dialogue data;
extracting dialogue experience data from a previous dialogue log;
determining a dialogue experience score that is obtained by quantifying, based on the dialogue experience data, a dialogue experience with given participants among the two or more participants;
determining a weight of each of the features associated with the activity score, based on the dialogue experience score; and
determining a dialogue evaluation score based on the activity score and the weight of each of the features associated with the activity score.

7. A non-transitory computer readable medium storing a program for causing a computer to execute the dialogue evaluation method of claim 6.
